(19) United States
(12) Patent Application Publication
(10) Pub. No.: US 2013/0045320 A1
(43) Pub. Date: Feb. 21, 2013

(54) METHOD OF PRODUCING LOW TRIGLYCERIDE OLIVE OIL AND NOVEL FRACTIONS

(71) Applicants: Thomas Gutierrez, St. Augustine, FL (US); Timothy A. Klapish, Raleigh, NC (US); Chad Harrell, Raleigh, NC (US); Leo Travino, Hurdle Mills, NC (US)

(72) Inventors: Thomas Gutierrez, St. Augustine, FL (US); Timothy A. Klapish, Raleigh, NC (US); Chad Harrell, Raleigh, NC (US); Leo Travino, Hurdle Mills, NC (US)

(21) Appl. No.: 13/370,435

(22) Filed: Feb. 10, 2012

Related U.S. Application Data
(63) Continuation-in-part of application No. PCT/US2010/045190, filed on Aug. 11, 2010.
(60) Provisional application No. 61/233,048, filed on Aug. 11, 2009.

(51) Int. Cl. A23D 9/02; C11B 7/00

(52) U.S. Cl. 426/601; 426/417; 554/206

(57) ABSTRACT

The present invention relates to a novel method for separating an edible oil, such as extra virgin olive oil, into useful fractions. In one embodiment the triglycerides are separated as a fraction and the remaining fractions recombined to form an olive oil with little or no triglycerides.

This application is a continuation-in-part application of PCT application number PCT/US2010/045190 filed on Aug. 11, 2010 which claims priority of U.S. provisional application No. 61/233,048 filed on Aug. 11, 2009 which are included herein in their entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to the treatment of a vegetable oil, such as olive oil, for removing a desired component from the oil. In particular, it relates to the removal of triglycerides or other compounds from olive oil and the like.

2. Description of Related Art

A number of vegetable oils are known to be beneficial in the diet when compared to animal based fats. Oils, such as olive oil, and especially extra virgin olive oil are known to be cardio protective and certain known fractions have been shown to have medicinal benefits.

Olive oil is known to be low in saturated fats and provides its health benefits due to phenolic content or fatty acid profile of the olive oil being responsible for cardioprotective benefits. Olive oil contains monounsaturated fats such as oleic acid and has antioxidants such asphenolics, Vitamin E, carotenoids and oleuropein. This fatty acid as well as linoleic and others make up the fatty acid portion of olive oil. The rancidity and taste grading of olive oil is tied to the presence of free, esterified oleic acid with grades of olive oil being made based on higher grades having a lower free oleic acid content. High acid content oils are frequently refined to chemically neutralize these compounds, though higher grade oils require that they cannot contain neutralized triglycerides and instead must just contain lower amounts or triglycerides.

Much research has been done into fractionating olive oil (as well as other beneficial vegetable oils) and testing the results. The two main methods of separation or removing unwanted components involve filtration or a liquid extraction process. While these methods of separation result in isolation of useful compounds they frequently do not separate out other undesirable compounds. For example, solvent liquid separation is known to separate based on polarity and thus, polar compounds which are undesirable accompany the desired components during separation. These methods do not single out triglycerides or other particular compounds.

In U.S. Pat. No. 5,089,139 to Asbeck issued Feb. 18, 1992 there is disclosed a method for refining virgin olive oil in which the virgin olive oil is filtrated by microfiltration techniques. This method avoids multi stage filtration techniques and use of a filtration aid. It is only capable of filtering out impurities below a certain concentration. In U.S. Pat. No. 6,849,770 to Guxman et al. issued Feb. 1, 2005 there is a method described for obtaining purified hydroxytyrosol from products and by-products derived from the olive tree by means of a two step chromatographic treatment. Other articles, and the like, also describe the isolation of organic compounds from olive oil waste.

Triglycerides are particular glycerides wherein the glycerol has been esterified with three fatty acids. They are a significant component in both animal fats and vegetable oils. The triglycerides present in vegetable oils, such as olive oil, are linked to disease, such as atherosclerosis and increased risk of heart disease and stroke. They have also been implicated in diabetes, pancreatitis, renal disease, and certain forms of primary hyperlipidemias. High triglyceride levels have also been associated with obesity.

Many organizations such as the American Heart Association and most experts recommend taking affirmative action to reduce triglyceride levels. One of those methods is based on the fact that reduced consumption of triglycerides can aid in a healthy lifestyle with lower triglycerides. It is known that even when triglyceride levels in food are high in infants and children it can lead to higher triglyceride levels and hypercholesteremia in adulthood. However, even healthy oils, such as olive oil, contain a certain amount of triglycerides. This is true even though extra virgin olive oil is lower in oleic acid than even other grades of olive oil. However, the lower the triglyceride levels in olive oil and other oils, the better the oils are considered for the diet.

### BRIEF SUMMARY OF THE INVENTION

The present invention relates to methods for fractionating edible vegetable oils, such as olive oil and in one embodiment extra virgin olive oil. By fractionating the olive oil on a solid stationary phase, it is possible to easily, quickly and cheaply produce olive oil with little or no triglyceride content.

Accordingly, in one embodiment of the present invention there is disclosed a method of isolating one or more fractions from an edible vegetable oil comprising:

a) loading the oil on a solid stationary phase;

b) passing two or more polar solvents through the solid phase;

c) collecting the oil fractions in polar solvent; and

d) separating at least one oil fraction from the polar solvent.

In yet another embodiment of the present invention there is disclosed an extra virgin olive oil having at least a portion of the triglycerides removed.

### BRIEF DESCRIPTION OF THE DRAWINGS

FIG. 1 is a TLC plate of SPE fractions collected using increasing solutions of increasing polarity.

FIG. 2 is a TLC plate of SPE fractions collected using reduced volumes for the collection of fraction 2.

FIG. 3 is a TLC plate of SPE fractions collected when testing to determine the maximum amount of sample that can be loaded on the column.

FIG. 4 is a block diagram of the small scale extraction process used to separate the components in olive oil.

FIG. 5 is a block diagram of the large scale extraction process used to separate the components in olive oil.

FIG. 6 is a TLC plate of large scale SPE fractions collected.

FIG. 7 is a flow chart of the collection process.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The terms “about” and “essentially” mean ±10 percent.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein “edible vegetable oil” refers to oils used in the food industry which have a portion of their content normally from triglycerides. Examples of edible vegetable oil include, olive oil including extra virgin olive oil (EVOO), corn oil, canola oil, and the like. In the embodiments wherein the edible oil is extra virgin olive oil, the oil can be from any source, noting that different sources present different profiles of triglycerides and other components capable of being fractionated. EVOO from countries such as the US, Spain, Italy, France, Israel, Middle Eastern countries, and the like are all contemplated within the scope of the invention.

A “fraction” as used herein refers to separating i.e. “isolating” one or more of the component compounds in the oil that make up the mixture that exists as the vegetable oil. Since all vegetable oils contain a number of component compounds, the oil can be separated into a large number of fractions if desired. However, if one desires only a particular fraction or compound, the number might only be two or three fractions or the like when separating the oil. In fact, how many fractions depends on which component is to be separated and where it comes off of the solid phase during the separation process. For example, in the example for isolating triglycerides in extra virgin olive oil, (there are a number of different triglycerides including oleic acid), it is the second fraction that contains the triglycerides necessitating three fractions to get the triglycerides isolated from the remainder of the olive oil components.

As used herein the phrase “solid stationary phase” refers to a solid phase used for a solid phase extraction process. In this process, which is normally used to concentrate and purify samples for analysis, it is used on food oils for the purpose of isolating useful components as well as remove unwanted components (in one embodiment triglycerides, such as oleic acid) from the oil. As such, its usefulness on a large scale was unknown until the present invention. Without the following results it was not known if this process could be used to commercially separate oils as described herein or what result would be obtained. The stationary phase is normally loaded into a column or other container such that the solid remains relatively fixed. That is, this phase does not move during the separation process. The solid phase must be a solid or semisolid which binds a vegetable oil, such as olive oil, for fractionation. Typically, one example is silica, however, other examples include, but are not limited to, silica derrvatized with functional groups such as OH (hydeoxyl), cyanol (—CN), aminei (—NH2), and amino (—NO2). Each component will bind itself differently to the stationary phase by use of a non-polar solvent. The compounds are then fractionated by washing with successively more polar solvents which disrupt the attractive interaction of the components and the stationary phase.

As used herein “loading an oil” refers to the process of binding the desired oils, such as olive oil, to the solid phase as a first step in the process. The loading process, as noted above, occurs with the oil in a non-polar carrier solvent. One skilled in the art in view of this disclosure can match the stationary solid phase with the loading solvent. In one embodiment, the loading solvent is heptane. Passing the heptane across the solid stationary phase loads the oil which binds the oil hydrophobically to the stationary phase. The amount of oil bound to the stationary phase and loaded by the loading non-polar solvent will depend on the number of available binding sites available, the loading, rate of speed of washing, and the like.

In order to separate an edible oil such as olive oil into at least two fractions, at least “two or more polar solvents” would be needed. Different fractions will each have one or more compounds from the mix of oil components in each fraction. One can select as many different graduated polar solvents to separate the components as far as is necessary. Once it is determined what fractions are necessary, or if a compound is being removed and remaining fractions recombined, it becomes more simple to pick solvents. As a particular solvent moves through the solid phase, depending on the solvent polarity and rate of elution, compounds will move through the solid phase at different rates causing separation of these compounds. Therefore, with even one polar solvent, many compounds can be found but separating the entire oil requires removing all the oil from the solid phase unless the last phase is the undesirable phase. However, the solvents will need to be polar and each pass of a solvent across the solid phase must be with a successively more polar solvent than the next.

In one embodiment, successively polar solutions of ethyl acetate are run across the solid phase and in the case of olive oil, can elute a linear triterpene fraction, a triglyceride fraction, and a last fraction of remaining components such as free fatty acids, cyclic triterpene, and phenolics. The first and last fraction can be recombined to form an olive oil free or essentially free of triglycerides. Other combinations and percentages of polar solvents can be used. However, for large scale separations, creating and packing the stationary phase may be altered and as such, a larger volume of polar solvent is usually necessary.

Each of the fractions which occur in the different polar solvents are collected separately and the oil fraction isolated by removing (separating) the fraction from the polar solvent. This can be done by evaporation or the like. Another separation method includes lyophelizahonl freeze-drying. In a large scale operation, a rotary evaporation system could be utilized.

The general process can then be outlined as loading the vegetable oil on a solid phase using a non-polar solvent. Then, two or more polar solvents pass over the solid phase elucidating the compounds which wash from each phase of the polar solvent at different rates. Portions of each solvent or entire passes of a single polar solvent are collected and the component in that fraction isolated. Where it is desired that a component, e.g. triglycerides, are to be removed from the oil, that fraction is collected and the remaining fractions recombined to form an oil with low or no triglycerides. Likewise, if a particular fraction or fractions of the oil has an important use, the faction can be isolated even on a large scale.

### EXAMPLES

Materials and Equipment for Example Separation
AND HM-202 Analytical balance, or equivalent balance capable of weighing to ±0.01 mg
Supelco Analytical Discovery SPE DSC-Si Silica Tube, 5 g, PN:52658-U, or equivalent
Ageia Technologies 120g Silica Flash Column, Cat No.: CS140120-0, or equivalent
Vacuum Pump, GAST, Model 1531-107B-G557X, or equivalent
SPE Vacuum Manifold, or equivalent
Yamato Rotary Evaporator, Model RE200, or equivalent
Yamato Water Bath Accessory, Model BM100, or equivalent
Digital Thermometer
ThermoElectron Corporation Savant SPD1010 SpeedVac Concentrator, or equivalent
Ethyl Acetate, HPLC grade or equivalent
Heptane, HPLC grade or equivalent
EMD 10 cm×20 cm Glass TLC Silica Gel 60 F₂₅₄ plate, Cat No. 5729-6
Kontes TLC reagent sprayer with 10 mL capacity, Catalog no. K422530-0010
5% Sulfuric Acid in Ethanol (TLC developing reagent)
Spanish Extra Virgin Olive Oil, 112-001-01-006-7449-03, exp Feb. 26, 2012

### Small Scale Extraction Process

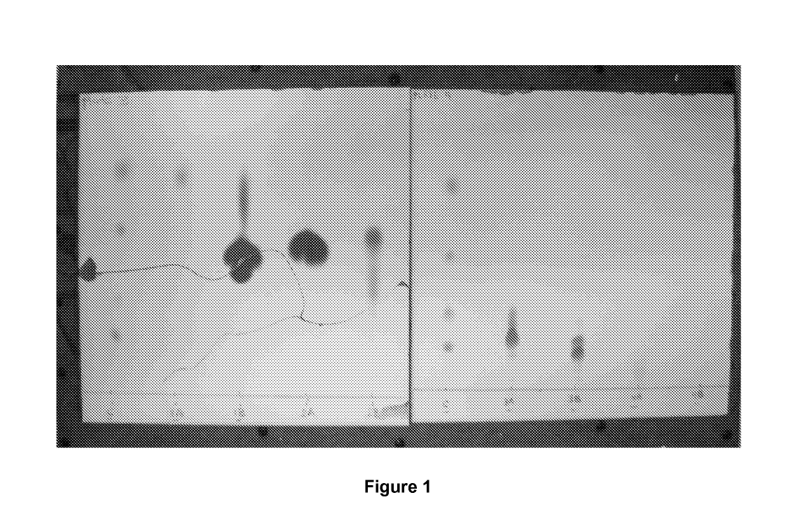

The material used for the small scale extraction process was Spanish Extra virgin olive oil (EVOO). Using previous data collected from thin-layer chromatography (TLC), trial separations were done to try and determine the best solvent compositions for the separation. Trial separations consisted of adding an EVOO sample solution to a 5 gram silica column attached to a collection setup, see FIG. 1 in priority application U.S. provisional application Ser. No. 61/233,048. The sample collection setup consists of an SPE column attached to a vacuum block with a low flow vacuum (2.5 kPa). The vacuum was adjusted such that the flow through the column was not greater than 1 mL/minute to limit channeling within the column.

Using two 10 mL volumes of solvent that had increasing concentrations of ethyl acetate in heptane, the sample was slowly eluted from the column. A TLC plate was run using the collected fractions, see FIG. 1, and the results suggest that a solution of 10% ethyl acetate in heptane was effective in removing the triglyceride from the sample. When the 20% ethyl acetate in heptane solution (20% EtAc) was applied to the column it began removing the compounds. Using this information, it was determined that the three solvent compositions that would be effective in removing the triglyceride from the oil sample were 3% ethyl acetate in heptane (3% EtAc), 10% ethyl acetate in heptane (10% EtAc), and 100% ethyl acetate (100% EtAc).

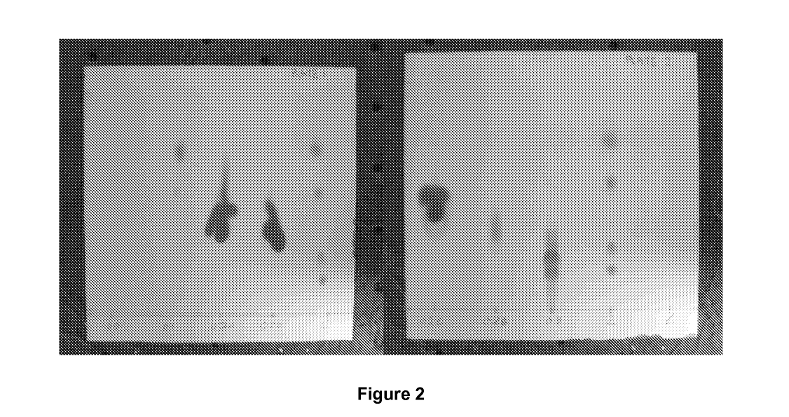

An experiment was also done to try and isolate the material presenting in front of the triglyceride peak, visible in lane 1B of FIG. 1. This consisted of doing four 10 mL volumes of 10% EtAc after the initial 10 mL of 3% EtAc was run through the column. After all of the fractions were collected, they were run on TLC plates for analysis. The TLC plates, see FIG. 2, suggest that the triglyceride starts to come off as soon as the 10% EtAc is added to the column and that the initial portion can't be removed.

An experiment was also performed to determine the maximum amount of oil that can be loaded onto the column. This consisted of using 1 g of Spanish EVOO per 3 g of silica, instead of a ratio of 1 g sample per 6 g silica that has been used in the previous experiments.

FIG. 1 is a TLC plate of SPE fractions collected using increasing solutions of increasing polarity. Marker “C” consists of squalene (top), cholesterol (second from top), oleic acid (third from top), and glyceryl triolate (fourth from top). Markers “1A” and “1B” were each 10 mL of 3% EtAc. Markers “2A” and “2B” were each 10 mL of 10% EtAc. Markers “3A” and “3B” were each 10 mL of 20% EtAc. Markers “4A” and “4B” were each 10 mL of 100% EtAc.

FIG. 2 is a TLC plate of SPE fractions collected using reduced volumes for the collection of fraction 2. Marker “C” consists of squalene (top), cholesterol (second from top), oleic acid (third from top), and glyceryl triolate (fourth from top). Marker “01” was a fraction containing 10 mL of 3% EtAc. Markers “02A” through “02D” were each fractions containing 5 mL of 10% EtAc. Marker “03” was a fraction containing 10 mL of 100% EtAc. (e-NB ref: 112-001-01-063).

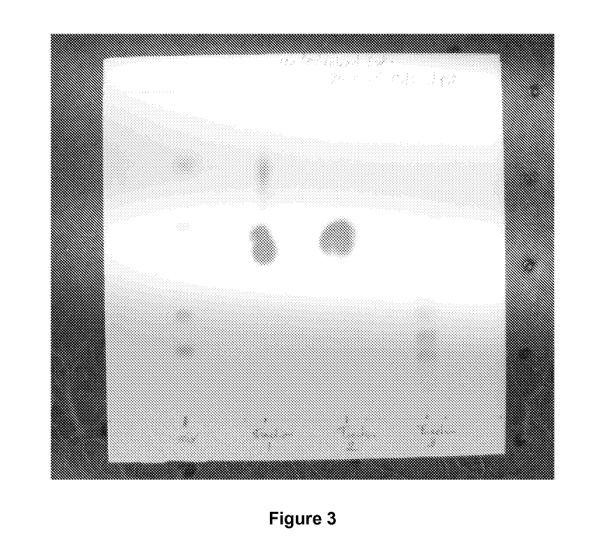

The TLC plate, see FIG. 3, which was developed, showed that triglycerides were present in the first fraction. This suggests that some of the compounds were unable to bind to the silica because there were no binding sites available. The results suggest that the column performs best when using silica ratio of 1:6.

FIG. 3 is a TLC plate of SPE fractions collected when testing to determine the maximum amount of sample that can be loaded on the column. Marker “Mix” consists of squalene (top), cholesterol (second from top), oleic acid (third from top), and glyceryl triolate (fourth from top). Marker “Fraction 1” was a fraction containing 10 mL of 3% EtAc. Marker “Fraction 2” was the second fraction which contained 17 mL of 10% EtAc. Marker “Fraction 3” was a fraction containing 20 mL of 100% EtAc.

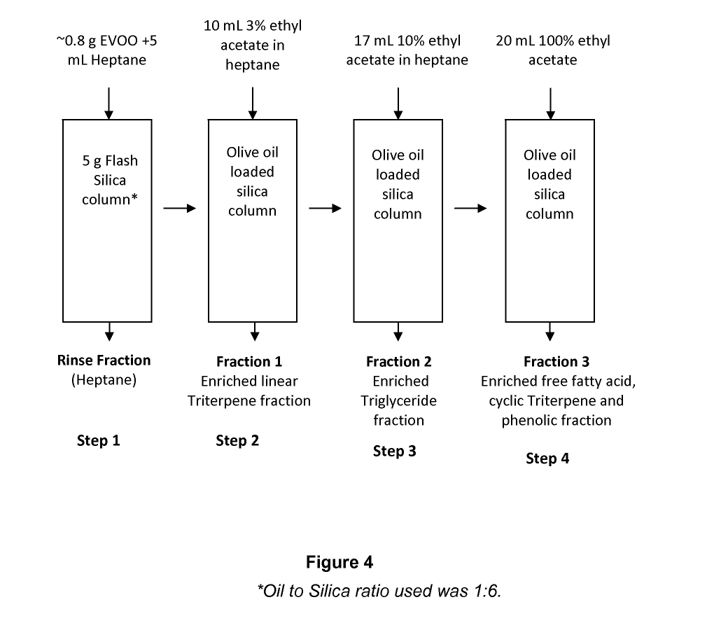

Using the information gathered, a final small scale extraction process was developed, see FIG. 4 for a diagram of the extraction process. One example is weigh out 5 grams of Spanish EVOO and combine it with 30 mL of heptane, mix the solution well. Add 5 mL of the EVOO sample to a 5 gram silica packed column that has been pre-washed with 20 mL of heptane. Rinse the column with 10 mL of 3% ethyl acetate in heptane and collect the fraction, this fraction should contain the enriched linear triterpenes. Rinse the column with 17 mL of 10% ethyl acetate in heptane and collect the fraction, this fraction should contain the triglycerides. Rinse the column with 20 mL of 100% ethyl acetate and collect the fraction, this fraction should contain the remaining enriched free fatty acid, cyclic triterpene, and phenolic compounds. Confirm the contents of all three fractions by TLC, or other suitable analysis method.

### Large Scale Extraction Process

A scaled up extraction process was designed to produce larger quantities of fractions and larger amounts of olive oil with triglycerides removed. Separations were done to refine the extraction process for use with the new column. All volumes were increased proportionally to match that of the 120 g silica column. Using the same collection setup previously used for the small scale fraction collections, the new column was setup and run using 20 g of sample.

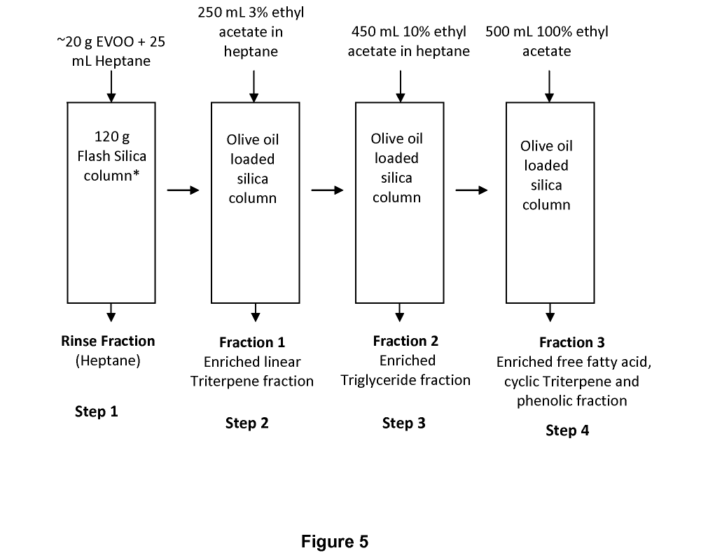

The extraction process was done the same way as the small scale collection, see FIG. 5. The volumes of both the samples and the solvents being used were increased proportionally to match the size increase of the column.

Multiple fractions were collected and each fraction was tested using TLC when each fraction came off of the column. Additional washes were added in-between each fraction collection to determine if all components of each fraction were removed. After all the fractions were removed they were then combined into three separate fractions. The first fraction containing the enriched linear triterpenes, the second containing the enriched triglycerides, and the third containing the enriched free fatty acids, cyclic triterpenes, and phenolics.

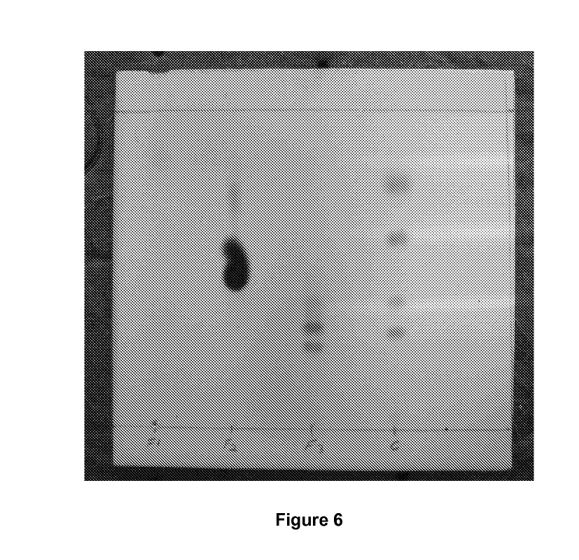

Using the final fractions, TLC analysis was performed and compared to a control sample, see FIG. 6. The fractions from all three separations appeared clean and were prepared to be evaporated down to dryness.

FIG. 6 is a TLC plate of large scale SPE fractions collected. Marker “C” consists of squalene (top), cholesterol (second from top), oleic acid (third from top), and glyceryl triolate (fourth from top). Marker “F1” was the first combined fraction containing ˜250 mL of 3% EtAc. Marker “F2” was the second combined fraction which contained ˜450 mL of 10% EtAc. Marker “F3” was third combined fraction containing ˜550 mL of 100% EtAc. (e-NB ref: 112-001-01-084).

### Rotary Evaporation of Final Collected Fractions

Fractions 1 and 3, from the large scale fractionation were evaporated to dryness using a combination of rotary evaporation and vacuum centrifugation. The samples were started in the rotary evaporator controlled to a temperature 30° C. When the fractions were reduced to approximately 10 mL of volume, they were transferred into a pre-weighted scintillation vial, placed in a vacuum centrifuge, and brought to dryness.

The final products were then re-weighed and their masses compared to the starting weights, see Table 1.

TABLE 1
Starting masses of EVOO samples and the masses of the dry,
recovered fractions.

| EVOO | | | | |
|---|---|---|---|---|
| Sample | Fraction 1 Dry | Fraction 1% | Fraction 3 Dry | Fraction 3% |
| Mass (g) | Mass (g) | Yield (w/w) | Mass (g) | Yield (w/w) |
| 20.0385 | 0.01710 | 0.0853 | 0.74675 | 3.7266 |
| 20.0065 | 0.01647 | 0.0823 | 0.67183 | 3.3581 |
| 20.0067 | 0.02599 | 0.1299 | 0.68781 | 3.4379 |

### Finalization

As the three extractions were done, the process was refined to limit the amount of separate fractions that would be required; however, it is still recommended that each fraction be tested before proceeding on to the next fraction. This extraction process can be scaled to match any application as long as the ratios of solvent to silica and sample to silica remain consistent, but minor changes might be required to allow for differences in the column packing process.

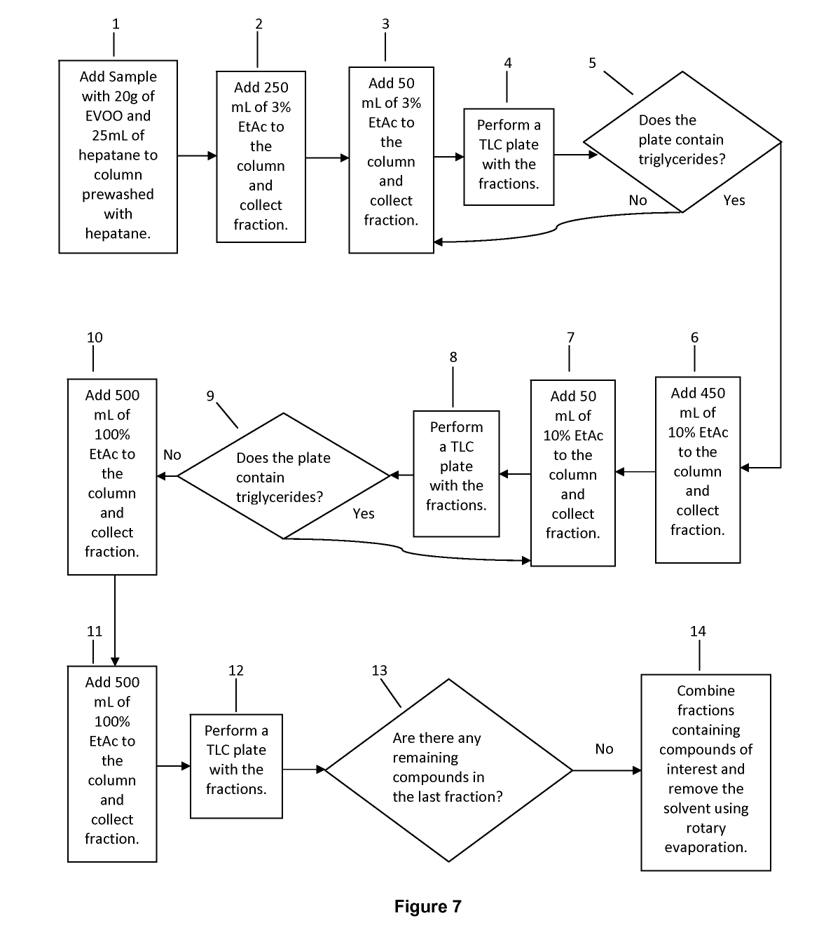

FIG. 7 shows a flow chart of an example of the collection process.

Weigh out 20 grams of EVOO and combine it with 25 mL of heptane, mix well 1. Add the entire sample to a pre-washed 120 gram column under vacuum (10-15 kPa) and collect the heptane waste. Add 250 mL of 3% ethyl acetate in heptane to the column and collect the sample fraction 2. Test each collected fraction by TLC analysis to confirm fraction content. Continue to add 50 mL washes of 3% ethyl acetate in heptane to the column 3 until the triglyceride appears in a TLC test plate 4 and 5. After triglyceride material appears, add 450 mL of 10% ethyl acetate in heptane and collect sample fraction 6. Continue to add 50 mL washes of 10% ethyl acetate in heptane to the column 7 until little to no triglyceride appears in a TLC analysis 8 and 9. Finally, add 500 mL of 100% ethyl acetate to the column to remove the remaining compounds of interest from the silica column 10. If desired, do an additional 50 mL wash of 100% ethyl acetate to determine if all visible compounds have eluted from the column 11, 12 and 13.

Combine the solutions containing the compounds of interest and using a rotary evaporator to remove the solvent from the bulk solutions at a controlled temperature of 30° C. 14. Once the samples are small enough to fit into a scintillation vial, transfer the sample, making sure to rinse the flask with an appropriate solvent. Insert the sample into a speedvac concentrator and evaporate the sample until dryness occurs.

### Conclusion

A process method to separate the fractions containing the enriched linear triterpenes, enriched free fatty acids, cyclic triterpenes, and phenolic compounds from the triglycerides in olive oil was developed. The developed method can be scaled to any application desired, with minimal changes required or scaled for use with other oils as desired.

Using this method, three separations were performed using a mean mass of 20.0172 g of Spanish extra virgin olive oil. The mean mass of enriched linear triterpenes recovered was 19.85 mg, with a percent yield of 0.0992% (w/w). The mean mass of the enriched free fatty acids, cyclic triterpenes, and phenolics was 702.13 mg, with a percent yield of 3.5075% (w/w).

What is claimed is:

1. A method of isolating one or more fractions from an edible vegetable oil comprising:
a) loading the oil on a solid stationary phase;
b) passing two or more polar solvents through the solid phase;
c) collecting the oil fractions in polar solvent; and
d) separating at least one oil fraction from the polar solvent.

2. The method according to claim 1 wherein a portion of the fractions are recombined to form an edible oil that has one or more fractions removed from the oil.

3. The method according to claim 2 wherein the oil is separated into at least 3 fractions.

4. The method according to claim 3 wherein one fraction contains triglycerides and is the fraction removed from the oil.

5. The method according to claim 4 wherein the oil is separated into a linear triterpene fraction, a triglyceride fraction and the remaining components of the oil fraction.

6. The method according to claim 1 wherein the oil is olive oil.

7. The method according to claim 6 wherein the olive oil is extra virgin olive oil.

8. The method according to claim 4 wherein the triglyceride is esterified oleic acid.

9. The olive oil made according to claim 4.

10. At least one isolated fraction of oil made according to claim 1.

11. The method according to claim 4 wherein the polar solvent used to elute triglycerides is ethyl acetate.

12. The isolated fraction of an oil isolated by the method of claim 1.

13. The method according to claim 1 wherein the solid phase is a silica.

14. The method according to claim 1 for separating olive oil into fractions comprising loading the oil on the solid phase followed by successively more concentrated solutions of ethyl acetate.

15. The method according to claim 13 wherein successive fractions are 3% ethyl acetate in heptane, 10% ethyl acetate in heptane and 100% ethyl acetate.

16. The method according to claim 1 for large scale separation of the oil.

17. Olive oil having at least a portion of the triglycerides removed.

18. Olive oil according to claim 17 wherein the triglyceride is esterified oleic acid.

19. The enriched linear triterpene fraction isolated from olive oil by the method of claim 1.

20. Extra virgin olive oil having at least a portion of the triglycerides removed.

21. The enriched free fatty acid, cyclic triterpene and phenolic fraction isolated from olive oil by the method of claim 1.
